(19) United States
(12) Patent Application Publication
(10) Pub. No.: US 2025/0217734 A1
(43) Pub. Date: Jul. 3, 2025

(54) SYSTEMS AND METHODS FOR PREDICTING UNNECESSARY RESOURCE UTILIZATION

(71) Applicant: Optum, Inc., Minnetonka, MN (US)

(72) Inventors: Citlalli S. BLANCHET, Palo Alto, CA (US); James M. DOLSTAD, Leavenworth, WA (US); Alice LI, New York, NY (US); Yao ZHANG, La Canada Flintridge, CA (US); Rajiv ARYA, Skillman, NJ (US); Maxine GOLDSMITH, West Hartford, CT (US)

(21) Appl. No.: 18/400,040

(22) Filed: Dec. 29, 2023

(51) Int. Cl. G06Q 10/0631; G06F 16/28; G06N 20/00; G06Q 50/26

(52) U.S. Cl. CPC G06Q 10/06312; G06F 16/287; G06N 20/00; G06Q 50/265

(57) ABSTRACT

Systems and methods are disclosed for predicting unnecessary resource utilization. A processor receives a first data object and generates for each member of a plurality of members a usage indicator for a pre-determined time period and a usage rate for the pre-determined time period. The processor generates each member of the plurality of members, based at least on the first classification data set, the second classification data set, the usage indicator, and the usage rate, a member optimization parameter. The processor generates based at least on the usage indicator, the usage rate, and the member optimization parameter for each member of the plurality of members, a plurality of cluster data objects, where members of each cluster data object are unique from members of any other cluster data object. The processor causes at least one of the plurality of cluster data objects to be displayed on a Graphical User Interface (GUI).

### TECHNICAL FIELD

Various embodiments of this disclosure relate generally to techniques for predicting unnecessary resource utilization, and, more particularly, to systems and methods for modeling predicted unnecessary resource utilization and interventions to increase efficiency of resource utilization.

### BACKGROUND

Emergency resources (e.g., emergency departments or systems) play a crucial role in providing rapid and comprehensive assistance during times of acute distress. However, emergency resources are often utilized for instances that are preventable if such unnecessary utilization were detected early and addressed via other intervention measures. This unnecessary utilization of emergency resources has been the subject of considerable concern and research due to its implications on costs, system bottlenecks, and entity assistance outcomes. Many approaches have been developed to mitigate unnecessary emergency resource utilization, such as triage protocols, remote entity assistance, and predictive modeling. However, these methods suffer from one or more issues and may be improved in one or more ways.

For instance, current methods struggle to accurately predict and target entities most likely to engage in unnecessary emergency resource utilization. Triage protocols are reactive rather than preventive and can't address the issue before the emergency resource is unnecessarily utilized. Remote assistance solutions may lack accessibility for certain entities, particularly those with limited technological literacy or resources. Predictive models currently in use often rely on generalized data, which may not accurately capture the nuanced factors contributing to unnecessary resource utilization.

Therefore, there is a need for a more sophisticated and accurate approach to predicting and mitigating unnecessary emergency resource utilization as well as the improvements achieved by mitigating unnecessary resource utilization.

This disclosure is directed to addressing the above-mentioned challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

The present disclosure addresses the technical problem(s) described above or elsewhere in the present disclosure and improves the state of conventional unnecessary resource utilization prediction techniques.

In some aspects, the techniques described herein relate to a computer-implemented method, the method including: receiving, by one or more processors, a first data object, the first data object including: a member data set containing a plurality of members; a first classification data set; a second classification data set; and a plurality of data sets associated with one or more metrics; generating, by the one or more processors and for each member of the plurality of members: a usage indicator for a pre-determined time period based on at least one of the member data set or one or more of the plurality of data sets associated with the one or more metrics, wherein generating the usage indicator is performed using a first machine-learning model trained to identify associations between prior usage of a resource and future usage of the resource; and a usage rate for the pre-determined time period based on the usage indicator and at least one of the member data set or one or more of the plurality of data sets associated with the one or more metrics; generating, by the one or more processors and for each member of the plurality of members, based at least on the first classification data set, the second classification data set, the usage indicator, and the usage rate, a member optimization parameter; generating, by the one or more processors, based at least on the usage indicator, the usage rate, and the member optimization parameter for each member of the plurality of members, a plurality of cluster data objects, wherein members of each cluster data object are unique from members of any other cluster data object; and causing, by the one or more processors, at least one of the plurality of cluster data objects to be displayed on a Graphical User Interface (GUI).

In some aspects, the techniques described herein relate to a system including: memory and one or more processors communicatively coupled to the memory, the one or more processors configured to: receive a first data object, the first data object including: a member data set containing a plurality of members; a first classification data set; a second classification data set; and a plurality of data sets associated with one or more metrics; generate for each member of the plurality of members: a usage indicator for a pre-determined time period based on at least one of the member data set or one or more of the plurality of data sets associated with the one or more metrics, wherein generating the usage indicator is performed using a first machine-learning model trained to identify associations between prior usage of a resource and future usage of the resource; and a usage rate for the pre-determined time period based on the usage indicator and at least one of the member data set or one or more of the plurality of data sets associated with the one or more metrics; generate for each member of the plurality of members, based at least on the first classification data set, the second classification data set, the usage indicator, and the usage rate, a member optimization parameter; generate, based at least on the usage indicator, the usage rate, and the member optimization parameter for each member of the plurality of members, a plurality of cluster data objects, wherein members of each cluster data object are unique from members of any other cluster data object; and cause at least one of the plurality of cluster data objects to be displayed on a Graphical User Interface (GUI).

In some aspects, the techniques described herein relate to one or more non-transitory computer-readable storage media including instructions that, when executed by one or more processors, cause the one or more processors to: receive a first data object, the first data object including: a member data set containing a plurality of members; a first classification data set; a second classification data set; and a plurality of data sets associated with one or more metrics; generate for each member of the plurality of members: a usage indicator for a pre-determined time period based on at least one of the member data set or one or more of the plurality of data sets associated with the one or more metrics, wherein generating the usage indicator is performed using a first machine-learning model trained to identify associations between prior usage of a resource and future usage of the resource; and a usage rate for the pre-determined time period based on the usage indicator and at least one of the member data set or one or more of the plurality of data sets associated with the one or more metrics; generate for each member of the plurality of members, based at least on the first classification data set, the second classification data set, the usage indicator, and the usage rate, a member optimization parameter; generate, based at least on the usage indicator, the usage rate, and the member optimization parameter for each member of the plurality of members, a plurality of cluster data objects, wherein members of each cluster data object are unique from members of any other cluster data object; and cause at least one of the plurality of cluster data objects to be displayed on a Graphical User Interface (GUI).

It is to be understood that both the foregoing general description and the following detailed description are example and explanatory only and are not restrictive of the detailed embodiments, as claimed.

### BRIEF DESCRIPTION OF THE DRAWINGS

The accompanying drawings, which are incorporated in and constitute a part of this specification, illustrate various example embodiments and together with the description, serve to explain the principles of the disclosed embodiments.

FIG. 1A is a diagram showing an example of a system configured for healthcare management, according to some embodiments of the disclosure.

FIG. 1B is a diagram of example components of a value impact platform, according to some embodiments of the disclosure.

FIG. 1C is a diagram of example components of a healthcare management module, according to some embodiments of the disclosure.

FIG. 2 is a flowchart showing a method for predicting unnecessary resource utilization, according to some embodiments of the disclosure.

FIG. 3 shows an example machine-learning training flow chart, according to some embodiments of the disclosure.

FIG. 4 illustrates an implementation of a computer system that executes techniques presented herein, according to some embodiments of the disclosure.

### DETAILED DESCRIPTION

The present disclosure relates to the field of data analytics and artificial intelligence. Various embodiments of this disclosure relate generally to techniques for predicting unnecessary resource utilization, and, more particularly, to systems and methods for modeling predicted unnecessary resource utilization and interventions to increase efficiency of resource utilization.

As previously discussed, current strategies to manage Unnecessary Emergency Department Utilization (UEDU) frequently fail in pinpointing and preemptively addressing the potential cases of non-emergency or preventable emergency department uses. These strategies often lack in providing individualized entity (e.g., patient) management, addressing communication deficiencies, ensuring steadfast adherence to external recommendations, and employing nuanced predictive models to grasp the subtleties of UEDU risks accurately.

To address these concerns, a centralized system and method are provided to facilitate thorough monitoring, analysis, and generation of interventions aimed at reducing UEDU. This system adeptly integrates multiple data sets, combining various attributes, events, and performance metrics of the entities. By employing advanced analytical methodologies, such as machine-learning algorithms, the system is adept at identifying patterns and correlations that suggest inefficient and/or unnecessary resource allocation or utilization and/or risks associated with UEDU. Furthermore, these analyses not only provide insights but also actionable recommendations to improve reduction of UEDU, thereby reducing resource utilization and improving entity care. Moreover, the systems and methods described herein leverage data that is unique to individual entities and addresses potential entity interventions at the entity-level. The system and method further include monitoring of the entity data and its changes over time, adjusting, updating, and retraining the applied models to account for changes in entity data, resulting in higher adoption of interventions, improved care pathways for the entities, and reduced complexity of medication protocols. The above technical improvements, and additional technical improvements, will be described in detail throughout the present disclosure. Also, it should be apparent to a person of ordinary skill in the art that the technical improvements of the embodiments provided by the present disclosure are not limited to those explicitly discussed herein, and that additional technical improvements exist.

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the disclosure is not to be considered as limited by the foregoing description.

Various non-limiting embodiments of the present disclosure will now be described to provide an overall understanding of the principles of the structure, function, and use of systems and methods disclosed herein for healthcare management outcomes.

Reference to any particular activity is provided in this disclosure only for convenience and not intended to limit the disclosure. A person of ordinary skill in the art would recognize that the concepts underlying the disclosed devices and methods may be utilized in any suitable activity. For example, while the present disclosure is in the context of healthcare management, one of ordinary skill would understand the applicability of the described systems and methods to similar tasks in a variety of contexts or environments. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of +10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

Training the machine-learning model may include one or more machine-learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-Prototypes or K-Means may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc. After training the machine-learning mode, the machine-learning model may be deployed in a computer application for use on new input data that it has not been trained on previously.

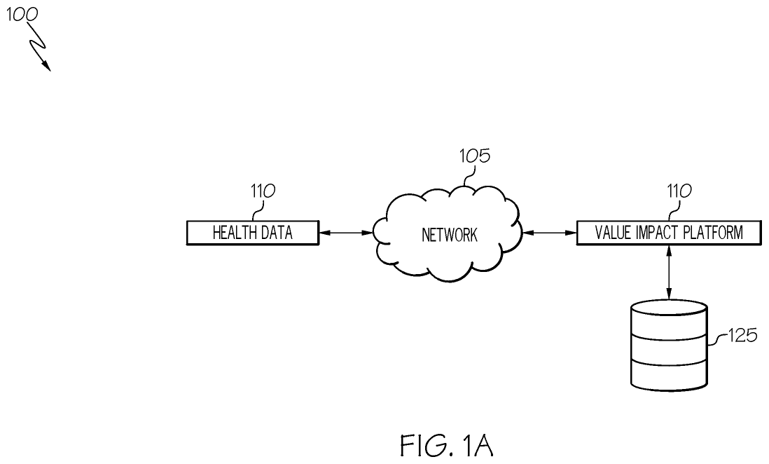

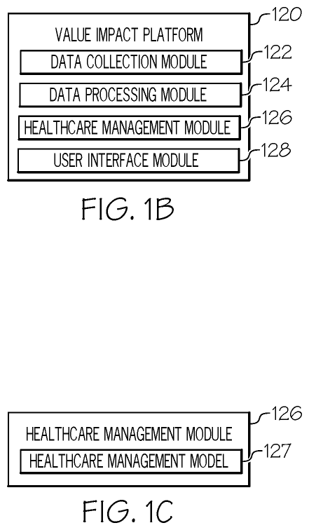

FIG. 1A is a diagram showing an example of a system that is capable of healthcare management, according to some embodiments of the disclosure. The depicted network environment, designated as 100, is in accordance with a specific embodiment of the current disclosure. The network environment 100 encompasses a communication infrastructure, such as network 105, which is accompanied by health data 110, and is further equipped with a value impact platform 120 integrated with a database 125.

In one embodiment, various components of the network environment 100 interact with each other through the network 105. The network 105 facilitates communication between the value impact platform 120 and one or more other systems, including one or more data sets, such as (but not limited to) health data 110. The one or more data sets and/or health data 110 includes data, data entries, and/or data objects associated with or comprising medical records. The network 105 includes one or more networks such as a data network, a wireless network, a telephony network, or any combination thereof.

The health data 110 encompasses an array of structured and unstructured information pertaining to the health of individuals. The health data, in some embodiments, is in the form of one or more data objects, and encompass various facets, including but not limited to, health plan-provider contracts, member files, provider records, PCP to member attribution, medical and pharmacy claims, as well as insights from Impact Analytics, geographical and context based pricing indexes, Social Determinants of Health (SDoH), NYU Avoidable Preventable classification, Admit, Discharge, Transfers (ADT), Area Deprivation Index (ADI), Rural Urban (RUCA), risk and quality analytics, and the like. This diverse health data repository, comprising details such as demographic data, medical histories, insurance claims, and other health metrics, finds its repository in storage, which in some embodiments takes the form of local or remote data storage solutions, including file servers and cloud-based storage systems, among others.

The database 125 is used to support the storage and retrieval of data related to one or more data sets and/or data objects, such as the health data 110, storing metadata and/or healthcare data about one or more populations represented in the health data 110, as well as any information received from the value impact platform 120. The database 125 can consist of one or more systems, such as a relational database management system (RDBMS), a NoSQL database, or a graph database, depending on the requirements and use cases of the network environment 100.

In one embodiment, the database 125 is any type of database, such as relational, hierarchical, object-oriented, etc., wherein data is organized in tables, lookup tables, or other suitable manners. The database 125 stores and provides access to data utilized by the value impact platform 120. The database 125 stores information related to the health data 110 as well as information generated by the value impact platform 120. The database 125 can store various types of information to aid in the healthcare management.

In one embodiment, the database 125 includes a machine learning-based training database that maps relationships, associations, connections, or the like between input parameters from the health data 110 and output parameters representing the one or more metrics for management of healthcare. For example, the training database can include machine learning algorithms that learn mappings between medical data inputs and one or more of utilization, adherence, or sensitive condition treatment outputs. The training database can be routinely updated based on additional machine learning.

The value impact platform 120 communicates with other components of the network 105 using known or developing protocols. These protocols govern interactions between network nodes and define rules for generating, receiving, and interpreting information sent over communication links. The protocols operate at different layers, from generating physical signals to identifying software applications sending or receiving the information.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers.

In operation, the network environment 100 provides a framework for analyzing large amounts of health data 110, leveraging data analytics, artificial intelligence, and database technologies to support various use cases and applications. For example, the network environment 100 can be used to generate metrics, data objects, and insights from one or more data sets, such as the health data 110, based on user-defined criteria or a plurality of parameters.

To perform these tasks, the value impact platform 120 utilizes techniques such as the healthcare management model 127 (FIG. 1C), which analyzes the health data 110 and identifies one or more healthcare management metrics, which in some embodiments match one or more specified criteria. The value impact platform 120 can also utilize the data collection module 122 and data processing module 124 (FIG. 1B) to gather and prepare the health data 110.

To support storage and retrieval of data related to the healthcare management metrics, the database 125 stores metadata about the health data 110, such as data sources, types, and formats. The database 125 also stores information about the health management metrics output by the value impact platform 120, such as health criteria, identifiers, and statistics.

In addition to healthcare management, the network environment 100 can support other applications like data visualization, search, and predictive modeling. For example, the network environment 100 could allow users using user devices to search the health data 110 for one or more metrics matching certain criteria, or visualize healthcare metric statistics through interactive graphs and charts.

FIG. 1B is a diagram of example components of a value impact platform 120, according to some embodiments of the disclosure. Referring to FIG. 1B, the value impact platform 120 is a component of the network environment 100. The value impact platform 120 provides the capabilities to analyze one or more data sets, such as health data 110 and generate one or more data objects including one or more healthcare management metrics. As used herein, terms like “component” or “module” encompass hardware and/or software implemented by a processor or the like. For example, the value impact platform 120 includes components for collecting, processing, and analyzing health data as well as generating one or more data objects including one or more healthcare management metrics. To that end, the value impact platform 120 includes modules such as a data collection module 122, a data processing module 124, a healthcare management module 126, and a user interface module 128. It is contemplated that the functions of these modules could be combined into fewer modules or performed by other modules with equivalent functionality.

In some embodiments, the data collection module 122 of the value impact platform 120 undertakes the collection of data from one or more data sets and one or more files, such as health data 110, during the operation of the environment 100. The data collection module 122 is equipped to receive a myriad of data types such as, but not limited to, health plan provider contract data, provider data, member data, PCP-to-member attribution data, medical and pharmacy claims data, proprietary or generated data, such as impact analytics data, pricing data, risk and quality analytics data, or the like, Healthcare Effectiveness Data and Information Set (HEDIS) quality metrics data, clinical prediction analytics, financial savings factors, Social Determinants of Health (SDoH) data, NYU Avoidable Preventable classification data, Area Deprivation Index (ADI) data, Admit, Discharge, and Transfer (ADT) data, Rural-urban Commuting Area (RUCA) data, and the like.

In some embodiments, the health plan provider contract data includes, but is not limited to, the identification and credentials of providers, specifics of the health plans offered, a compilation of service and billing codes, agreed reimbursement rates, payment terms, the scope of benefit coverage, eligibility prerequisites for patients, protocols for authorizations and referrals, quality and performance benchmarks, procedures for dispute resolution, duration and termination information, privacy and confidentiality terms, regulatory adherence protocols, amendment procedures for the contract, utilization review guidelines, potential risk-sharing agreements, credentialing processes for healthcare providers, specifications regarding pharmacy formularies, and the like.

In some embodiments, the provider data includes, but is not limited to, identifiers such as names, addresses, contact details, specialties, qualifications, and tax identification numbers associated with providers. The dataset also includes credentialing information, which verifies the qualifications and backgrounds of the providers, their affiliations with hospitals or other medical institutions, the insurance plans they accept, and their availability for patient appointments. In addition, the provider data contains historical data on the types and volumes of procedures performed, quality of care metrics, patient outcomes, and satisfaction scores, as well as data on billing practices and reimbursement rates.

In some embodiments, the member data includes, but is not limited to, identifiers such as names, birth dates, and member identification numbers associated with members. It further contains demographic details like addresses, contact information, gender, and employment information if relevant to the health plan. The health-related aspects of the dataset cover a member's entire medical history with the plan, including plan enrollment dates, coverage details, dependents, benefit utilization records, and claims history. Additionally, it includes members' health conditions, diagnoses, treatment histories, and outcomes.

In some embodiments, the PCP-to-member attribution data includes, but is not limited to, one or more mappings between primary care providers (PCPs) and their attributed members, thereby identifying and/or linking individuals enrolled in a health plan and their designated primary caregivers. It includes data related to member identification numbers, names, and demographic information, alongside corresponding identifiers and credentials of the attributed PCPs. The PCP-to-member attribution data includes the duration of the member-PCP relationship, visit histories, and the nature of primary care services rendered. Additionally, in some embodiments, it includes data on care continuity, referral patterns, and the effectiveness of the PCP in managing the member's health, including preventative care and chronic disease management.

In some embodiments, medical and pharmacy claims data includes, but is not limited to, comprehensive records of members' interactions with healthcare systems, reflecting services rendered and pharmaceuticals provided. This includes data on claims submissions, detailing dates of service, types of services, service providers, claim amounts, and payment outcomes. Each entry correlates with member identification numbers and the associated healthcare providers or pharmacies. The medical and pharmacy claims also includes diagnostic codes, procedure codes, and pharmacy billing information, providing insights into the medical conditions treated and the medications dispensed. Furthermore, in some embodiments, the medical and pharmacy claims includes a historical overview of members' claims over time, which can be analyzed to ascertain patterns in healthcare utilization, medication adherence, and the overall efficiency of healthcare services delivered.

In some embodiments, impact analytics data, such as data generated from a proprietary analytics engine, includes but is not limited to, one or more datasets which provide insights and/or data related to healthcare efficiency, costs, and outcomes. The impact analytics data aggregates and analyzes various aspects of healthcare services, encompassing medical claims, pharmacy claims, clinical data, and program participation records. It includes metrics on healthcare utilization, financial performance, clinical outcomes, and patient adherence to treatment regimens. Additionally, in some embodiments, this data encompasses predictive analytics on risk stratification, care gaps, and potential interventions. The dataset also integrates benchmarking against normative data or best practices, thereby enabling healthcare providers and payers to measure the effectiveness of their services against established standards.

In some embodiments, pricing data, such as data generated from a proprietary pricing engine, includes, but is not limited to, extensive datasets focused on the financial aspects of healthcare services. It encapsulates information on current market rates for various medical procedures and services, pharmaceutical pricing, and the costs associated with different healthcare providers. The data comprises details on negotiated contract rates, reimbursement models, historical pricing trends, and comparative analysis across different regions or service providers. Additionally, in some embodiments, the pricing data may integrate cost forecasting, budget impact models, and scenario analyses

In some embodiments, risk and quality analytics data, such as data generated from a proprietary analytics engine, includes but is not limited to, an array of data points that enable evaluation and monitoring of the quality, efficiency, and safety of healthcare delivery that encompasses risk assessments, quality measures, patient safety indicators, and compliance with clinical guidelines. The risk and quality analytics data includes outcomes data, risk adjustment factors, and analytics related to population health management. Additionally, in some embodiments, the risk and quality analytics data includes data related to care management programs, member health assessments, and provider performance evaluations.

In some embodiments, Healthcare Effectiveness Data and Information Set (HEDIS) quality metrics data includes, but is not limited to, one or more standardized performance measures that are used to assess the quality of care and services provided by health plans. The HEDIS quality metrics data includes one or more indicators across various domains of care, including preventive health services, chronic disease management, mental health care, substance use treatment, care coordination, and the like. It includes data related to healthcare effectiveness, patient safety, timeliness of care, and patient engagement. Additionally, in some embodiments, the HEDIS quality metric data may also encompass measures of utilization and risk-adjusted health outcomes.

In some embodiments, clinical prediction analytics data includes, but is not limited to, patient demographics, historical clinical data, treatment records, real-time health monitoring data, and the like. The prediction analytics data, in some embodiments, includes data generated by one or more predictive models and algorithms that analyze patterns in the data to anticipate future health events, such as hospital readmissions, disease progression, or the likelihood of specific health conditions developing. Additionally, in some embodiments, the clinical prediction analytics data includes data indicative of risk scores, potential gaps in care, and suggested preventative measures.

In some embodiments, financial savings factors data includes, but is not limited to, data related to cost avoidance, reduction in unnecessary medical procedures, efficiencies gained through improved care coordination, and savings from formulary management in pharmacy benefits. Additionally, in some embodiments, the financial savings factors data includes data on member cost-sharing amounts, provider network contracting savings, and the impact of wellness programs on overall healthcare costs.

In some embodiments, Social Determinants of Health (SDoH) data includes, but is not limited to, data points related to non-medical factors influencing patient health outcomes. This data encompasses socio-economic status, education level, neighborhood and physical environment, employment status, social support networks, and the like. The SDoH data, in some embodiments, includes information collected through patient surveys, community health assessments, and public health databases. Additionally, in some embodiments, the SDoH data includes indicators of health disparities, access to healthcare services, and environmental risk factors.

In some embodiments, NYU Avoidable Preventable classification data includes, but is not limited to, data related to metrics that categorize healthcare events deemed either avoidable or preventable with proper and timely medical care, patient education, and other interventions. This classification data includes data elements such as emergency department visits that could be managed in primary care settings, hospital admissions for conditions preventable through outpatient services, and incidences of chronic disease complications that can be mitigated through proper management and lifestyle adjustments. Further, the SDoH data includes measures of healthcare system efficiency, patient engagement in preventive care, and effectiveness of community health initiatives.

In some embodiments, Area Deprivation Index (ADI) data includes, but is not limited to, data that ranks neighborhoods by socioeconomic status disadvantage in a region or across the nation. The ADI data includes data related to as income, education, employment, housing quality, and other socioeconomic factors which demonstrate disparities across different regions. The ADI data, in some embodiments, is arranged by region, such as by zip code.

In some embodiments, Admit, Discharge, and Transfer (ADT) data includes, but is not limited to, operational data detailing patient movement within a healthcare facility or across facilities. This dataset includes timestamps and related information for patient admissions, discharges, and transfers among different departments or care settings. The ADT data, in some embodiments, is collected in real-time, facilitating immediate updates to a patient's status and location. Additionally, in some embodiments, the ADT data includes identifiers that can be used to track patient flow, manage bed occupancy, and coordinate care transitions effectively.

In some embodiments, Rural-urban Commuting Area (RUCA) data includes, but is not limited to, data that categorizes regions, such as U.S. census tracts, using measures of population density, urbanization, and daily commuting. The RUCA data, in some embodiments, provides a data relating to the rural-urban continuum, distinguishing between areas, such as metro and rural. Additionally, in some embodiments, the RUCA data includes the primary commuting flows to identify the social and economic integration of locales.

The data is ingested into the system via multiple pathways, thereby providing flexibility in the collection mechanism. Specifically, one pathway includes an Application Programming Interface (API) that establishes a secure communication channel for automated data transfer between the data collection module 122 and external data sources, thus facilitating real-time or batch-based data acquisition. Another pathway allows for manual input by authorized users via a dedicated user interface, where such input can be executed through file uploads or direct data entry into predefined fields. Additionally, data intake can be accomplished through third-party integrations, middleware, or direct database queries that serve to populate the database 125. The data collection module 122 further incorporates data validation and integrity checks to ensure the consistency and reliability of the ingested data. By offering a plurality of data intake methodologies, the data collection module 122 ensures robust and comprehensive data assimilation for downstream processing.

The data processing module 124 of the value impact platform 120 partakes in the processing and preparation of the data for further analysis by the healthcare management module 126. The data processing module 124 engages in the cleaning of the data, removal of irrelevant or redundant information, and conversion of the data into a format suitable for further processing by the healthcare management module 126. The data processing module 124 is configured to augment the initial data collection by transforming the raw, heterogeneous data into a unified, standard format, which is indispensable for accurate and efficient downstream processing. Specifically, the data processing module 124 executes a series of algorithms responsible for data standardization, thereby reconciling discrepancies in data types, units, or terminologies originating from disparate sources.

The data processing module 124 also integrates error-handling mechanisms to identify and rectify potential data inaccuracies or anomalies. Such mechanisms may involve rule-based checks, probabilistic data matching, or data imputation techniques, all aimed at preserving data quality and integrity. Furthermore, the data processing module 124 may incorporate parallel processing capabilities to concurrently handle multiple data streams, thereby ensuring timely and efficient data throughput. This is particularly advantageous when dealing with large-scale data sets or real-time analytics where swift data processing is desired.

The healthcare management module 126, upon receiving the prepared data from data processing module 124, applies algorithms and models, such as healthcare management model 127, to generate one or more data objects including one or more healthcare management metrics, based on the input data. The healthcare management module 126 utilizes various algorithms and employs a variety of models to accomplish its task. The healthcare management module 126 engages in the computational manipulation of the ingested data. Utilizing the healthcare management model 127 as one among a possible array of analytical frameworks, the healthcare management module 126 applies a combination of algorithmic and machine-learning methodologies to generate one or more healthcare management metrics based on the input data. Such metrics serve as quantifiable representations of various aspects of healthcare management.

In one embodiment, the healthcare management module 126 applies algorithms related to clinical opportunities methodology. This methodology integrates diverse sets of processed data, such as medical claims, financial data, and clinical histories, to produce a healthcare management metric that reflects opportunities for cost and quality optimization in healthcare delivery.

In another embodiment, the healthcare management module 126 employs machine-learning-based prediction algorithms to produce metrics that predict future healthcare events. These could include patient risk stratification or likelihood of hospital readmission, or the like. The predictive models, which are a part of the healthcare management model 127, use features extracted from the processed data, such as social determinants of health, historical medical data, area deprivation index scores, one or more other features extracted from the processed data as discussed herein, or a combination thereof.

Additionally, the healthcare management module 126 may use value impact modeling to generate healthcare management metrics that evaluate the resource efficiency (such as economic, staffing, or material usage implications) of distinct clinical interventions or pathways. These metrics are derived from simulations that are conducted using various models, each designed to measure the financial impact of specific healthcare decisions.

The healthcare management module 126 may further produce healthcare management metrics that represent aggregated patient worklists or next-best-action recommendations. These metrics are formulated through a combination of rule-based algorithms and probabilistic models, which evaluate and incorporate variables like HEDIS quality metrics and medical and pharmacy claims.

After the healthcare management module 126 has generated the one or more data objects including one or more healthcare management metrics based on the input data, a user interface generated on a user device via the user interface module 128 displays the results to the user at an appropriate time. The user interface provides an interactive and intuitive interface, enabling the user to view, modify, or confirm the generated results. The user interface also enables the user to provide feedback or additional information to improve the healthcare management process or adjust the healthcare management model 127 accordingly. The user interface module 128 is also configured to receive a user input via an interactive interface, the user input being one or more parameters.

FIG. 1C is a diagram of example components of a healthcare management module 126, according to some embodiments of the disclosure. FIG. 1C provides a more detailed view of the healthcare management module 126 and its relationship with the healthcare management model 127 within the value impact platform 120. As depicted, the healthcare management module 126 includes a healthcare management model 127. The healthcare management model 127 is configured or trained to determine appropriate healthcare management metrics, in the form of one or more data objects, related to resource utilization (e.g., emergency department utilization, hospital utilization in general, etc.), care adherence, care outcomes, resource efficiency, and the like, based on various factors, such as those reflected in the health data 110. Furthermore, the healthcare management model 127 also takes into account changes to the health data and/or to the populations within the health data to increase the likelihood of an accurate response.

The healthcare management model 127, as part of the healthcare management module 126, orchestrates the creation of healthcare management metrics, such as data objects, from health data 110. This algorithm is agnostic to its underlying implementations and is designed to accommodate various types of algorithms, either individually or in combination, to achieve the desired outcomes. In some embodiments, the healthcare management metrics generated by the healthcare management model 127 pertain to predicted utilization of resources and services, projected complexity of medication regimens, identified categories associated with risks and/or severities, or other relevant aspects related to patient care and treatment planning. It should be noted that while the described implementation involves a predictive model, alternative configurations incorporate other models or approaches depending upon the specific needs and requirements of the healthcare facility and patients served. For example, the healthcare management model 127, in some embodiments, analyzes historical patterns in healthcare usage data to develop predictions about future trends. This information is then be used to optimize staffing levels, inventory management, equipment maintenance schedules, and other logistical considerations necessary for providing efficient and effective medical care. Additionally, the generated metrics assist clinicians in identifying patients who would benefit from targeted interventions or early discharge planning efforts, thereby reducing hospital stays and improving overall patient health outcomes.

In some embodiments, the value impact platform 120 is configured to support contract ingestion and standardization. The data collection module 122 is configured to receive contract terms among other types of healthcare-related data. Upon collection, these contract terms are forwarded to the data processing module 124. The data processing module transforms the heterogeneous contract data into a unified, structured format that is suitable for subsequent processing by the healthcare management module 126 and storage within the database 125.

The data processing module 124 employs algorithms designed specifically for contract standardization. These algorithms reconcile variances in contract terminologies, units, and conditions, thereby eliminating inconsistencies that could potentially impact the quality of the generated healthcare management metrics. This standardization process results in the normalization or standardization of contracts from disparate sources that can be accurately compared, analyzed, and integrated within the overarching healthcare management framework enabled by the value impact platform 120.

In addition to terminology reconciliation, the data processing module 124 performs the task of structuring the ingested contract data. This involves breaking down complex contract clauses into constituent elements, which are then mapped to predefined fields within the database 125. By doing so, the data processing module 124 ensures that the contract data is organized in a manner conducive to efficient query execution and data retrieval. Following the completion of the contract ingestion and standardization process, the standardized contract data is stored in the database 125 and is made accessible to the healthcare management module 126 for subsequent analytical operations.

In some embodiments, the data processing module 124 is configured to combine two or more contracts for the purpose of generating healthcare management metrics. The platform identifies contracts with terms sufficiently similar to warrant amalgamation into a single data object. Subsequently, these unified contract data objects are stored in the database 125 and are rendered accessible to the healthcare management module 126 for further analytical activities. The data processing module 124 incorporates rules-based mechanisms or utilizes one or more models or algorithms to establish the suitability of combining specific contracts. In a rules-based approach, pre-defined combination rules are set by one or more users of the system. These rules specify criteria that contract terms must meet to be considered similar, such as identical service categories, payment models, geographical locations, or the like. In some embodiments, the data processing module 124 employs computational models or algorithms to assess the suitability of contracts for combination. These algorithms analyze attributes such as contract duration, parties involved, and other contractual elements, and apply statistical or machine-learning techniques to make determinations on whether contracts can be combined together.

Once contracts are combined into single data objects, the user, through the user interface module 128, is enabled to select these combinations for analysis. The healthcare management module 126 then generates one or more healthcare management metrics or reports based on the combined contract data objects. The system is further designed to allow the user to modify the selection of combined contracts. Upon such re-selection, the healthcare management module 126 automatically re-generates the healthcare management metrics or reports to reflect the updated corpus of selected contracts.

In some embodiments, the value impact platform 120 generates one or more performance reports for the individual or combined contracts. This performance reporting is formulated based on a combination of input data and the standardized or amalgamated contract data objects stored in the database 125.

In one embodiment, the healthcare management module 126 employs algorithms related to financial performance reports. These algorithms integrate the standardized contract data with other forms of healthcare data, such as medical and pharmacy claims, HEDIS quality metrics, clinical prediction analytics, or the like, to yield a performance report that assesses the financial implications of the individual or combined contracts. The report may cover aspects such as cost-efficiency, quality of care, and adherence to contract terms, among other criteria. For example, the healthcare management module 126 combines one or more of health plan provider contracts data, member data, provider data, PCP-to-member attribution data, medical claims data, pharmacy claims data, impact analytics data, or risk and quality analytics data to create historical and current project financial performance reports, which in some embodiments are based on a single contract and in some embodiments are based on combining two or more contracts to create an aggregated balance sheet.

In another embodiment, the healthcare management module 126 uses the clinical opportunity identification methodology to generate performance reports. This methodology combines the contract data, whether individual or combined, with clinical histories, social determinants of health, or other relevant healthcare data to identify opportunities for clinical improvements and cost savings. The resulting performance report would provide a granular analysis of the efficacy and efficiency of healthcare service delivery as stipulated by the contract terms.

For contracts that have been combined, the healthcare management module 126 is configured to generate a unified performance report that represents the aggregated impact of the bundled contracts. This unified report would comprise metrics such as cumulative cost savings, overall quality improvement, and combined compliance rates, synthesized from the individual contracts included in the combination.

Further, in some embodiments, the system enables the user, through the user interface module 128, to interact with the generated reports. Users can select different combinations of contracts, prompting the healthcare management module 126 to re-calculate and re-generate performance reports based on the newly selected combinations. This adaptability ensures that users obtain tailored insights that cater to different analytical needs.

In some embodiments, the healthcare management module 126 is configured to perform tasks related to clinical and quality modeling. The module receives input data and standardized or combined contract data from the database 125 and applies a series of algorithms and models for the generation of clinical and quality metrics. These metrics pertain to the assessment of healthcare services, patient outcomes, and compliance with established healthcare standards. The healthcare management module 126 incorporates specific algorithms designated for evaluating quality metrics such as HEDIS scores, patient satisfaction rates, and clinical effectiveness measures. These algorithms integrate with the contract data to discern how specific contractual terms and conditions influence quality outcomes. For example, an algorithm may assess how a payment model specified in a contract impacts the healthcare provider's adherence to HEDIS standards. Similarly, the module includes clinical modeling capabilities that employ advanced algorithms or machine-learning models. These clinical models may incorporate multiple variables from the input data, including but not limited to medical and pharmacy claims, member eligibility, and social determinants of health, to produce actionable insights. For instance, the module could utilize an algorithm that integrates patient medical histories and contract-specific guidelines on pharmaceutical usage to determine optimal drug regimens for individual patients. Moreover, the clinical and quality metrics generated can be included as part of broader performance reports. These reports may be displayed through the user interface module 128, which allows users to interact with and interpret the metrics, thereby enabling more informed healthcare management decisions.

For example, healthcare management module 126 is configured to combine one or more of health plan provider contracts data, member data, provider data, PCP-to-member attribution data, medical claims data, pharmacy claims data, impact analytics data, pricing data, SDoH data, NYU Avoidable Preventable classification data, ADT data, ADI data, RUCA data, or the like, to identify population clinical opportunities, such as described further herein.

For example, healthcare management module 126 is configured to combine one or more of health plan provider contracts data, member data, provider data, PCP-to-member attribution data, or risk and quality analytics data to perform one or more modeling and/or generate one or more model related to HEDIS quality and Medicare accuracy diagnosis and coding opportunity generation.

For example, healthcare management module 126 is configured to combine one or more of health plan provider contracts data, member data, or the like, to generate one or more reports related to aggregated current patient worklist across medical, pharmacy, HEDIS quality and suspect conditions.

For example, healthcare management module 126 is configured to combine one or more of health plan provider contracts data, member data, provider data, PCP-to-member attribution data, medical claims data, pharmacy claims data, impact analytics data, pricing data, SDoH data, NYU Avoidable Preventable classification data, ADT data, ADI data, and RUCA data, risk and quality analytics data, or the like, to generate one or more of estimated costs savings assigned across clinical modeling with redundant savings removed, estimated revenue assigned to suspect conditions, recommend interventions to clinical and care coordination staff, or one or more additional reports related to healthcare management.

In instances where combined contracts are used, the healthcare management module 126 is further configured to generate clinical and quality models that reflect the aggregate effect of these combined contracts. For instance, a unified quality model might be generated that blends the quality metrics from multiple contracts to offer a holistic view of healthcare service quality across an entire healthcare network.

In some embodiments, the healthcare management module 126 incorporates functionalities designed for dynamic scenario modeling. Specifically, the module enables the modeling of scenarios that simulate the impact of various improvement opportunities on performance metrics, particularly with respect to financial, clinical, and quality dimensions. This capability allows users to forecast the outcomes of potential actions or interventions within the healthcare system. For instance, the dynamic scenario modeling employs a modeler which is configured to capture the top n common payer scenarios. This modeler assimilates information from diverse data sources such as financial models, clinical histories, and quality metrics, all of which are stored in the database 125. The modeler then utilizes these data points in conjunction with the contract data, whether individual or combined, to generate a set of scenario options. In some embodiments, the modeler utilizes one or more reports, such as a financial reporting, opportunity model, savings opportunity modeling, clinical modeling, or the like, to generate interactive scenario modeling, enabling a user to steer interventions and resource allocation to optimize contract obligation fulfillment and workload.

Understanding that medical groups often operate under resource constraints, the dynamic scenario modeler allows the user to selectively focus efforts on one or two key metrics with the objective of optimizing performance against contractual targets. Users interact with this feature via the user interface module 128, where they can specify the level of resource allocation they wish to devote to particular opportunities for improvement. For example, in some embodiments, a user might elect to focus on optimizing HEDIS quality metrics. The dynamic scenario modeler would then simulate the impact of such an optimization on financial performance, considering parameters such as reimbursement rates stipulated in the contract or contracts. Simultaneously, the dynamic scenario modeler would also forecast the implications on clinical performance metrics, such as patient health outcomes or admission rates. By way of another example, in some embodiments, the user could decide to emphasize efforts on cost-saving measures in pharmaceutical spending. Here, the dynamic scenario modeler generates a scenario illustrating how such an effort would affect not just financial metrics like overall spending, but also quality metrics like patient satisfaction and clinical efficacy. In cases involving combined contracts, the dynamic scenario modeler is further configured to aggregate the impacts across the multiple contracts, providing a consolidated view of how resource allocation in selected areas would influence performance metrics at a holistic level.

In some embodiments, the health management module 126 is configured to generate one or more aggregated members lists, such as an aggregated high risk members list. In some embodiments, the health management module 126 generates reports, scenario models, and clinical and opportunity models across multiple clinical opportunities, and aggregates patients across multiple clinical opportunities, savings modeling, and intervention recommendations to create a single clinical outreach list.

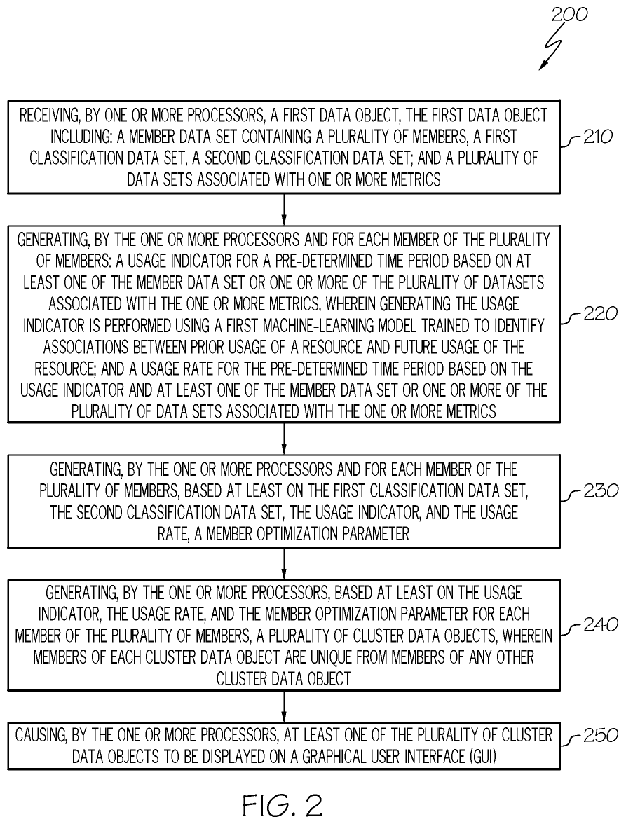

FIG. 2 is a flowchart showing a method for predicting unnecessary resource utilization (e.g., emergency department utilization). In step 210, the value impact platform 120 receives a first data object. This first data object is a collection of data sets: a member data set containing details about a plurality of members, a first classification data set, a second classification data set, and a plurality of data sets associated with one or more health metrics. The first data object forms part of, or constitutes the entirety of, the health data 110. The member data set includes data related to one or more members, including one or more profiles associated with each member. As described previously, such member data includes, but is not limited to, a member's identification details, demographic information, historical and current health conditions, claims data, utilization of healthcare service, risk stratification metrics, and the like. The first classification data set includes data related to NYU Avoidable Preventable classification data as described herein. The second classification data set includes data related to Agency for Healthcare Research and Quality (AHRQ) classifications, which includes healthcare services data, diagnosis and procedure codes, cost and utilization data, quality and outcome measure data, and the like. The plurality of data sets associated with one or more health metrics includes, but is not limited to, member file data, provider data, medical and pharmacy claims data, impact analytics data related to members and chronic conditions, pricing data (e.g., pricing data related to allowed amounts within the last 12 months for inpatient, out-patient, and specialist referrals), SDoH data, chronic conditions flags, geographic information and location lists of hospitals, emergency departments, and urgent care centers, and one or more data sets that are described elsewhere in this disclosure and not part of the member data set and the first and second classification data sets.

The data sets in the first data object include one or more data arrays, which may take the form of client data arrays, impact data arrays, or classification data arrays, among other types. These data arrays may encapsulate specific types of information, such as physical roster arrays, member list arrays, medical claims data arrays, and pharmacy claims data arrays, or the like. In some embodiments, the member data set, the first and second classification data sets, and the plurality of data sets associated with one or more health metrics include one or one or more of these arrays. These arrays collectively serve as a multi-dimensional repository for storing and organizing the data elements needed for subsequent processing and analysis by the value impact platform 120.

The client data set or client data array within the first data object serves to store and organize information relevant to individual members. These data sets or arrays encapsulate a rich set of member-specific information, thereby functioning as a data source for the subsequent operations carried out by the value impact platform 120. Specifically, the client data set or array may include various forms of data objects, such as physical roster arrays, member list arrays, medical claims data arrays, and pharmacy claims data arrays, or the like. A physical roster array within the client data set typically includes data fields that contain the physical locations or addresses of the members. In some embodiments, this facilitates determining accessibility to healthcare facilities. The member list arrays may hold demographic and identifying details about each member, such as age, sex, and unique identification codes. The medical claims data arrays capture transactional data regarding the medical services availed by the members, providing a historical snapshot of healthcare utilization. Similarly, the pharmacy claims data arrays contain records of pharmaceutical prescriptions and dispensations for each member.

The impact data set or impact data array captures specific metrics and indicators that relate to healthcare resource utilization, particularly in the context of emergency department (ED) visits. These data sets or arrays are contained within the first data object and serve as key informational sources for the value impact platform 120. Specifically, the impact data set or array may include unnecessary or inappropriate emergency department utilization flags, or the like.

A unnecessary or inappropriate emergency department utilization flag within the impact data set is typically a binary data field that indicates whether a given ED visit was deemed unnecessary or avoidable based on pre-established criteria. These flags are generated and assigned based on various factors, such as diagnostic codes, clinical evaluations, or utilization history. In some embodiments, these flags are dynamically updated to reflect changes in member behavior or healthcare policy guidelines.

In addition to individual flags, the impact data array in some embodiments includes aggregated data fields that summarize inappropriate or unnecessary ED visits over specific time periods. These aggregated data fields facilitate trend analysis and forecasting, enabling healthcare providers and policy makers to make more informed decisions.

The classification data set or classification data array incorporates clinically relevant classifications such as Agency for Healthcare Research and Quality (AHRQ) avoidable and preventable classifications, Current Procedural Terminology (CPT) codes pertaining to severity levels, NYU classification codes relating to preventable conditions and chronic conditions, or the like. In some embodiments, the first classification data set includes AHRQ classification and a second classification data set includes NYU codes.

In the classification data set, each data entry corresponds to a healthcare event and is tagged with one or more classification markers. These markers delineate the nature of the healthcare event, including its preventability, severity, and associated clinical procedures. For example, an AHRQ avoidable classification would indicate that the healthcare resource utilization for a particular event could have been prevented through timely and effective care. On the other hand, CPT codes provide granularity in assessing the complexity and resource intensity of medical procedures. NYU codes identifying chronic conditions which may have alternative pathways of care to avoid preventable resource utilization.

The classification data array organizes these classification markers into structured formats that facilitate quick access and computational efficiency. The array structure is optimized for complex queries and downstream processing by the data processing module 124. The array can be programmatically accessed to extract subsets of data that meet specific criteria, such as healthcare events that are both preventable and of high severity, thereby facilitating targeted analysis.

Additionally, Operational Intelligence (OI) data set or OI data array incorporates one or more parameters, preferences, or the like. In some embodiments, the OI data array is a repository of operational metrics and indicators. These metrics include contract terms, such as reimbursement rates, quality measures, or any other contractually defined criteria. Additionally, the OI data set encompasses SDoH data, offering insights into environmental, social, and economic factors that influence health outcomes. Examples of SDoH data could be housing status, access to transportation, food security indicators, and the like.

The various data arrays, including but not limited to the client data array, impact data array, classification data array, and OI data array, are configured to be interoperable within the confines of the network environment 100, particularly as managed by the value impact platform 120. Interoperability of these data arrays implies that the data arrays are formatted, structured, or encapsulated in such a manner as to allow for seamless exchange, integration, or utilization across modules or functionalities. This enables the creation of a composite first data object, which in some embodiments constitutes a portion or the whole of health data 110, without loss of information fidelity, coherence, or semantics.

At step 220, the value impact platform 120 generates a usage indicator and a usage rate for a pre-determined time period for each member of the plurality of members. In some embodiments, this includes the generation, by a processor, of two primary outputs for each member. These outputs include a usage indicator and a usage rate, both based on a predetermined time period. The generation of these outputs leverages data from at least one of the member data set or one or more of the plurality of data sets associated with the one or more health metrics.

The usage indicator serves to establish a predictive model for resource utilization of the healthcare system by each member. This prediction takes into account the past and current health data, alongside other qualifying factors such as geographical data and claims data. Specifically, the value impact platform 120 may use an algorithm or a machine-learning model to evaluate a multitude of data arrays or data objects, thereby deriving an indicative value or flag. This indicative value provides a probabilistic assessment of a member's likely engagement with emergency department resources within the upcoming predetermined time period.

In some embodiments, the usage rate is computed based on the aforementioned usage indicator and additional data sets, including at least one of the member data set of one or more of the plurality of data sets associated with the one or more health metrics. This rate approximates the frequency of the predicted resource utilizations, such as emergency department visits, for each member over the forthcoming predetermined time period. The computation of the usage rate involves, in some embodiments, the application of a machine-learning model trained to learn associations between a member's medical data and anticipated frequency of resource utilizations.

The generation of the usage indicator in step 220 constitutes an aspect of the method for predicting unnecessary resource utilization. The value impact platform 120 computes this usage indicator for a predetermined time period, relying on information sourced from the member data set and one or more of the plurality of data sets associated with various health metrics. In some embodiments, one or more additional data sets associated with the user and/or health metrics is utilized, such as claims data.

The value impact platform 120 initiates the computation by accessing the member data set, which includes information about the individual members, such as age, prior medical history, claim utilization, and other demographic factors. Additionally, the value impact platform 120 fetches data from health metrics data sets, which may encompass variables like historical spend, risk profile, educational level, historical claims data, and the like. The value impact platform 120, in some embodiments, applies one or more filters to the member data prior to generating the usage indicator. The value impact platform 120 identifies members within the member data set that have a resource utilization, such as an emergency department visit, within a predetermined time frame, such as the last 12 months. In some embodiments, one or more additional filters are applied to the member data set, such as identifying a distance from a hospital to a member's primary residence.

To calculate the usage indicator, the value impact platform 120 applies a predictive model to the data. This model may be an algorithmic construct, a machine-learning model, or a composite of multiple discrete models or algorithms, as embodied in the healthcare management model 127. These models are trained to learn associations between the input data variables and the likelihood of a member utilizing emergency department resources. This allows the model to formulate and output a predictive score, flag, or indicator that signifies the probability of such utilization for each member within the upcoming predetermined time period. In some embodiments, the models are updated and/or adjusted periodically based on one or more data received by the value impact platform 120, further optimizing the model's configuration to predict one or more associations.

In some instances, the model produces a binary output, such as a “yes” or “no” indicator or flag, suggesting whether a member is likely to have at least one emergency department utilization within the predetermined time period. In other embodiments, the model outputs a risk score. This score is then compared against an indicator threshold risk value, which is in some embodiments pre-determined, adjusted by a user, or dynamically adjusted to maximize efficiency depending on available resources.

Various types of data contribute to the usage indicator's calculation, such as: User Data: Personal information, lifestyle factors, or the like; Claims Data: Historical data on previous medical service utilizations; Geographical Data: Proximity to healthcare facilities, localized health risks, or the like. The calculated usage indicator is then stored in an associated data array or object, such as by augmenting an existing member profile or by creating a new data object that includes only members identified with a high likelihood of resource utilization. The usage indicator serves, in some embodiments, as a prediction that the member will have at least one resource utilization, such as an emergency department visit, within a predetermined time frame, such as the next 12 months. The calculation of the usage indicator is, in some embodiments, based on the application of a logistic regression model to one or more data received by the value impact platform 120.

The generation of a usage indicator for each member in the member data set serves as a precursor, in some embodiments, to the creation of a target population data object. The target population data object is a data structure that encapsulates information about a sub-group of members who are identified as being at high risk of unnecessary resource utilization based on their computed usage indicators. This object is generated and managed by the value impact platform 120, interfacing with both the healthcare management model 127 and the database storing the member data set.

Upon calculating individual usage indicators, the value impact platform 120 sorts these indicators in a predetermined manner, such as ascending or descending order, or within specific value ranges or bins. In one embodiment, the value impact platform 120 compares each computed usage indicator to a threshold value. Members whose usage indicators exceed this threshold value are then flagged for inclusion in the target population data object. The threshold value is in some embodiments derived from a variety of sources including but not limited to historical data, predictive analytics, or a composite of statistical measures. This value serves as a cut-off point to delineate members who are considered high-risk from those who are not. The objective is to identify a group of members for whom interventions may be most effective, as these members are deemed to have a higher likelihood of unnecessary resource utilization, based on the predictive capabilities of the healthcare management model 127.

The value impact platform 120 creates the target population data object by aggregating the identified members and their corresponding usage indicators. In addition to the usage indicators, the target population data object also stores additional attributes for each member, including: Member Identifiers: Unique identifiers such as Member ID, Social Security Number, or the like; Demographic Data: Age, gender, geographical location, or the like; Additional Health Metrics: Vital signs, historical health data, or the like.

Subsequent to the creation of the target population data object, the value impact platform 120 further refines or manipulates this object based on additional criteria or data inputs. For example, the value impact platform 120 segments the target population data object into sub-groups based on various factors like age, geographic location, or specific health metrics. These sub-groups are then analyzed separately for more granular healthcare management.

In some embodiments, the value impact platform 120 generates a usage rate. The generation of the usage rate leverages, for each member, the generated usage indicator and is based on at least one of the member data set or one or more of the plurality of data sets associated with one or more health metrics. The usage rate is an estimate of the number of predicted resource utilizations, such as emergency department visits, for an upcoming period of time.

The value impact platform 120 utilizes the previously generated usage indicator, which is in the form of a binary output or a risk score, as an input for the generation of the usage rate. Further, the value impact platform 120 relies on additional data sets, potentially encompassing member medical history data, geographical data, claims data, or the like. The member data set includes, but is not limited to, data arrays such as client data arrays, impact data arrays, classification data objects, or OI data arrays, which are sourced from health data 110.

The value impact platform 120 executes a machine-learning model trained to recognize patterns and associations between the member's medical data and their potential resource utilizations in an upcoming period. The machine-learning model, which is in some embodiments incorporated within the healthcare management module 126. For each member, the model receives the usage indicator and the relevant data sets as inputs and outputs a predicted resource utilization count for the member for the upcoming predetermined time period. In some embodiments, the value impact platform 120 applies an XGBoost model to the data to estimate the visit counts over an upcoming period of time.

The output of the machine-learning model manifests as a usage rate, which estimates the number of predicted resource utilizations, such as emergency department (ED) visits, for each member for an upcoming period of time. For example, the model is applied to the data associated with a particular member and outputs a predicted usage rate of 3.5 ED visits for the subsequent 12-month period.

The predetermined period for which the usage rate is generated is, in some embodiments, manually set by a user or, in some embodiments, defined by one or more contract terms. The model and thereby the usage rate are adaptable and are in some embodiments dynamically updated or adjusted based on the latest data inputs and performance metrics. The value impact platform 120 also updates the member profile or other relevant data objects to reflect the newly generated usage rate. The usage rate generated is subsequently employed in combination with other elements, such as the first classification data set, the second classification data set, and additional health metrics, for further analyses or actions, such as generating a member optimization parameter or clustering the members.

At step 230, the value impact platform 120 generates, for each member of the plurality of members, and based at least on the first classification data set, the second classification data set, the usage indicator, and the usage rate, a member optimization parameter. The value impact platform 120 utilizes the first and second classification data sets to categorize each member's predicted resource utilization. These classification data sets include but are not limited to AHRQ avoidable and preventable classifications, flags, and CPT codes for severity levels. The processor maps each member to one or more categories within these classification data sets to assess the type and severity of resource utilization. The value impact platform 120 further considers the usage indicator and the usage rate, which have been generated in previous steps. Both the usage indicator and the usage rate are utilized in calculating the member optimization parameter.

The member optimization parameter is computed to identify predicted resource utilization encounters that may be avoidable or modifiable. For example, based on AHRQ classifications or CPT codes specific to severity levels, the value impact platform 120 identifies encounters that could potentially be handled through alternative, less resource-intensive means.

Additionally, the member optimization parameter accounts for alternative resource utilizations other than emergency department (ED) visits. These alternatives serve as offsetting factors, effectively aiming to reduce the total predicted resource utilization. For example, if a member's condition can be adequately managed through a telehealth appointment rather than an ED visit, this alternative resource utilization is factored into the member optimization parameter.

In some embodiments, the member optimization parameter is a total resource utilization reduction metric. The total resource utilization reduction metric serves as a quantifiable measure indicating the effectiveness of utilizing resources in the healthcare context. Specifically, this metric quantifies cost savings by identifying avoidable or modifiable predicted resource utilizations and providing alternative, less expensive care paths. The metric is generated by the data processing module 124 and can be used to guide healthcare management decisions.

The value impact platform 120 uses AHRQ classifications in conjunction with the member optimization parameter to identify predicted resource utilizations that are avoidable or modifiable. AHRQ classifications offer a structured framework that includes categories for severity, urgency, and the necessity of healthcare resource utilization. By matching members to these categories, the value impact platform 120 segregates utilizations that could be circumvented or changed, which then become components in calculating the total resource utilization reduction metric. The future resource utilizations that may be avoidable are identified based on the usage indicator and the associated member's prior utilization data, such as the reason for the utilization and if the prior utilization was also avoidable. Further member data is, in some embodiments, utilized, such as geographic location, medical data, or the like.

The value impact platform 120 further considers Current Procedural Terminology (CPT) codes for identifying alternative care paths that could serve as offsets to the original predicted resource utilization. For instance, a CPT code representing a telehealth visit may indicate a less resource-intensive and less expensive healthcare option compared to an emergency department visit. These potential offsets are factored into the total resource utilization reduction metric as reduced costs.

For each member, or in some embodiments for each member with an indicated predicted resource utilization, the value impact platform 120 associates costs with both the original predicted resource utilization and the potential offset resource utilization. These costs can be derived from a pre-determined cost data set that includes average or specific costs associated with different types of healthcare resource utilizations, categorized by AHRQ classifications and CPT codes. In some embodiments, the cost is further derived from the member's geographical location, and in some embodiments considers one or more contract terms associated with the member. The total cost savings for each member is then determined by subtracting the reduced costs associated with the offset care path from the original costs of the predicted resource utilization.

The total resource utilization reduction metric thus encapsulates cost savings for each member by integrating both avoidable predicted resource utilizations and the costs associated with alternative care paths. This metric serves as an actionable output for the healthcare management module 126, allowing for the tailoring of interventions and care plans for individual members or groups of members.

At step 240, the value impact platform 120 generates a plurality of cluster data objects, wherein members of each cluster data object are unique from members of any other cluster data object. The generation of these cluster data objects is based upon one or more data inputs, including but not limited to: the usage indicator, the usage rate, and the member optimization parameter for each member in the plurality of members. The resulting clusters are unique, such that members of each cluster data object are unique from the members in any other cluster data object.

In certain embodiments, the value impact platform 120 generates specifically three types of cluster data objects based on predefined criteria: A low-priority cluster data object, and medium-priority cluster object, and a high-priority cluster object. The low-priority cluster data object includes members who are determined to have a low likelihood of addressing and/or reducing the predicted resource utilization through one or more utilization. In some embodiments, this cluster encompasses members characterized by higher education levels and low healthcare spending. The medium-priority cluster data object includes members who are determined to have a medium likelihood of addressing the predicted resource utilization through one or more intervention. This cluster can include members facing financial insecurity who are either healthy yet at risk or have a chronic condition and are at risk. The high-priority cluster data object includes members who are determined to have a high likelihood of addressing and/or reducing the predicted resource utilization through one or more intervention. This cluster can comprises older members at a higher risk of elevated emergency department spending. It will be appreciated that the clustering includes more or less than three clusters, and is based on one or more additional and/or alternative metrics.

In some embodiments, the clustering is executed based on one or more types of data included in the first data object. The types of data include, but are not limited to: Historical Spend: The value impact platform 120 utilizes historical healthcare spending data associated with each member; Risk: Risk factors, potentially encompassing medical history, current conditions, and projected future health events, are also considered; Education Level: Data regarding the education level of each member is factored into the clustering algorithm; Age: Age data for each member can also serve as a basis for clustering, one or more outputs of the value impact platform 120 or the like.

Each cluster data object is a data container that holds member-specific data, including but not limited to the usage indicator, usage rate, and member optimization parameter. The cluster data object also includes additional fields that represent the criteria and data types used for clustering, such as historical spend, risk factors, education level, or age. In some embodiments, the method includes labeling the one or more cluster data objects. Each label is a discrete identifier that encapsulates key characteristics of the cluster data object it is associated with. These characteristics can include, but are not limited to, predominant risk factor, average historical spend, median age, or common education level within the cluster. The labeling, in some embodiments, is considered fingerprinting, and the method further includes indexing or storing the fingerprint of the cluster data object in a historical database for later retrieval.

In some embodiments, the clustering is performed by the value impact platform 120 utilizing and/or applying a predictive grouping model. In some embodiments, the predictive grouping model is trained to assign members to clusters utilizing one or more cluster algorithms during a training process, such as a KPrototype cluster algorithm. Existing members are assigned to clusters, and the model learns the relationship between member data and predicted utilizations and one or more cluster classifications. For new members, cluster labels are then predicted by the value impact model 120 applying KNeightbors classifier model to the member data to predict one or more cluster labels for the member.

At step 250, the value impact platform 120 causes at least one of the plurality of cluster data objects to be displayed on a graphical user interface (GUI). The GUI serves as a visual representation component, offering the end user, for example a healthcare administrator or a healthcare provider, a visual framework for interacting with the data generated by previous steps in the method for predicting unnecessary resource utilization 200. GUI is a part of the user interface module 128 within the value impact platform 120.

In some embodiments, the value impact platform 120 generates a series of data visualization constructs, such as charts, tables, or graphs, within the GUI. These constructs are formulated based on the cluster data objects, which are themselves generated in step 240. Each of these data visualization constructs corresponds to a unique cluster data object and contains information pertaining to the members of that cluster, such as historical spend, risk level, education level, and age, or the like.

It should be noted that the GUI enables dynamic interaction with the data visualization constructs. For instance, an end user could initiate a drill-down operation on a particular data point within a chart to obtain a more granular view of the member's data attributes, such as usage indicators, usage rate, or member optimization parameter. Moreover, the GUI allows the user to toggle between different views or apply filters to highlight specific subsets of data based on parameters such as AHRQ classification, CPT codes, or the like.

Furthermore, the GUI also provides actionable insights by incorporating a series of control elements, such as buttons or drop-down menus. These control elements allow the end user to invoke various functionalities of the healthcare management module 126. For instance, the end user might initiate an action to update the healthcare management model 127, apply a different classification or risk threshold, change the selected contracts, or activate a specific healthcare intervention strategy for a target cluster or individual member.

In another embodiment, the value impact platform 120 is configured to automatically update the GUI at predetermined intervals, or in response to certain triggering events, such as changes in the member data set, updates in classification data, or adjustments in the healthcare management model 127. This automatic updating ensures that the most current and relevant information is always displayed, thereby facilitating timely and data-driven decision-making processes.

In some embodiments, the value impact modeler 120 generates one or more savings opportunity models. The value impact modeler 120 incorporates the first and second classification data sets to determine if one or more claims are avoidable. Specifically, the AHRQ classification data is applied to one or more outputs to determine classification of severity of a condition related to an ED visit and utilizes NYU classification data to determine which conditions may be preventable. Utilizing this data, along with procedure codes to identify severity levels of the visit and zip codes to identify both ER and intervention costs from the CompPricer data set, the value impact platform 120 generates an estimated savings related to intervention. The estimated savings for each member is calculated by comparing the total costs of past ED utilizations with the costs of interventions, and in some embodiments the likelihood of intervention success. This is done by multiplying the past costs of services by the number of visits a member has had and then subtracting the cost of intervention. The difference reveals the potential savings per member, a reduction in overall resource utilization.

In some embodiments, the method further includes the generation of one or more interventions. The generation of interventions is considered intervention modeling. The generation of interventions involves, among other steps, the output of a plurality of cluster data objects at step 240, which serve as preliminary categorization mechanisms for the population of healthcare system members based on various criteria such as historical spend, risk, education level, age, and the like. The interventions are generated with a focus on resource efficiency, specifically aimed at reducing unnecessary emergency department (ED) utilization while ensuring effective patient care.

In some embodiments, one or more intervention data objects or arrays are generated. The intervention data object or array, in some embodiments, includes one or more cluster data objects and the members associated with the one or more cluster data objects. For each member, one or more interventions are assigned to the member. The intervention, in some embodiments, is associated with one or more alternative paths of care, which is associated with a particular resource utilization. The intervention is in some embodiments assigned by the value impact platform 120 utilizing one or more machine-learning models and/or algorithms to output an intervention that results in the most efficient resource utilization, such as by suggesting an intervention by diverting the member to an alternative care pathway based on one or more of member data, the likelihood of success of the intervention, the expected resource utilization (such as cost) of the intervention, or the overall reduction in resource utilization of the alternative care pathway.

Interventions are of varied types and include but are not limited to medication management, virtual nurse consultations, in-home support services, and mental health assessments. These interventions are not limited to emergency department utilization issues and encompass a range of healthcare needs. The interventions are applied either at a member-level or at a cluster data object level. When applied at a member-level, each member receives a personalized recommended interventions based on their medical history, risk factors, and other variables such as geographic location or distance to hospital. When applied at a cluster data object level, all members of the particular cluster receive a common set of interventions optimized for that cluster's average or median characteristics. In some embodiments, each member within each cluster will receive an ordered set of one or more recommendations, the ordered set based on the presence or absence of one or more data indications that the member has one or more conditions, such as a chronic condition such as asthma, COPD, cardiac disease, or the like. In some embodiments, one or more interventions are applied to a cluster and at least a portion of those applied interventions are, for each member, ordered based on one or more data indications associated with the member.

The generation of interventions also incorporates an efficiency metric that accounts for the effectiveness of the interventions in reducing unnecessary resource utilization, such as emergency department visits. This efficiency metric is quantified in terms of reduction in resource utilization, and is often balanced against the cost of the intervention to ensure that the overall healthcare system achieves cost savings.

The estimation of medical cost savings involves multiple components, including the identification of members suitable for intervention based on their historical ED visits, applying cost benchmarks to these identified members, and finally applying a quantification of savings based on the selected intervention. For example, the calculation might involve the number of ED users for a specific condition, a predicted utilization reduction percentage, and an estimated cost savings per avoided ED visit.

In some embodiments, based on the generated interventions, a current member worklist object for ED diversion is generated, wherein each member or a group of members belonging to a particular cluster data object receives specific interventions. The healthcare management module 126 employs the healthcare management model 127 to generate this worklist data object, taking into account the member optimization parameter generated in step 230, usage rate from step 220, and the categorization data from step 240.

In some embodiments, the success of one or more interventions is tracked by the healthcare management module 126. Tracking involves the monitoring and recording of key performance indicators such as ED utilization rate, patient satisfaction, and overall healthcare cost reduction. The collected data is subsequently used to refine the healthcare management model 127 for future scenario modeling predictions. Specifically, the realized success rates of the interventions are incorporated into the model's underlying algorithms, enabling the model to adapt and improve its accuracy in generating subsequent interventions. The ongoing integration of real-world performance data thus contributes to the continual calibration of the healthcare management model 127, thereby facilitating more precise and efficient allocation of healthcare resources.

In some embodiments, as discussed above, the value impact platform 120 performs intervention modeling. The intervention modeling initiates with the development of interventions, derived from a combination of clinical knowledge and expert judgment. As discussed herein, the value impact platform 120 deploys a K-mean cluster analysis, which in some embodiments builds a plurality of clusters (such as 2-7 clusters) of members and/or interventions. Each resulting cluster is characterized by a clinical summary that indicates what sets of tools and/or interventions are best suited for the member population that cluster encapsulates. The model utilizes one or more unique prediction algorithms, where each cluster employs a specific machine-learning algorithm, such as random forest, XGBoost, or decision trees, to accurately forecast future healthcare costs or pinpoint target variables.

The value impact modeler 120 accounts for anticipated healthcare needs of the members, which are categorized in some embodiments as high, medium, or low, and aligns the member with the cluster which that best fits the member's future consumption patterns based on the prediction of visit utilizations and rates over a 12 month period. Each cluster is provided a digital fingerprint-a set of defining characteristics that are subject to evolution in tandem with the member population associated with that cluster. The fingerprint is dynamic, such as when member population characteristics change, the fingerprint updates to reflect the changes. This dynamic nature of the cluster enables value impact modeler 120 to adapt, modify, or further train one or more machine-learning models to the modified cluster, minimizing tracking errors as the population demographics and health profiles evolve, responding to the process of population health initiatives and member engagement.

In some embodiments, the method further includes generating one or more scenario model data objects. The scenario model data object represents suggested areas of focus, such as particular interventions, which drive the overall member population towards one or more population states that achieve one or more targeted goals. These goals, defined in the scenario model data object, pertain to the optimization and influencing of one or more metrics related to resource utilization, improved patient outcomes, reduced costs, or the like.

The generation of these scenario model data objects is facilitated by value impact platform 120, through the data processing module 124 and the healthcare management module 126. By leveraging data from health data 110 and other relevant sources, the scenario modeling system analyzes, evaluates, and predicts the potential impact of specific interventions or changes within the network environment 100.

In some embodiments, the scenario modeling operates by weighting one or more metrics or outcomes to determine the optimal course of action for the healthcare system. Each metric or outcome is assigned a weight based on its significance or impact on the overall goals of the system. These weights can be predefined based on industry standards, historical data, or input by healthcare professionals or administrators who use the value impact platform 120. They can also be dynamically adjusted to reflect the changing priorities or objectives of the healthcare system. Moreover, the weighting is adjusted dynamically based on the changes to the overall population or changes in contract terms.

The weighting of metrics or outcomes allows the scenario modeling system to balance multiple considerations, such as clinical effectiveness, cost-efficiency, patient satisfaction, and regulatory compliance. For example, if the healthcare system aims to reduce unnecessary emergency department visits while maintaining a high level of patient satisfaction, the scenario modeling system can adjust the weights assigned to these outcomes to find a suitable balance of utilization reduction and alternative care pathway adoption, which in some embodiments would signify patient satisfaction with their medical care.

The user interface module 128 provides a comprehensive visualization of the scenario model data object. It allows users, such as healthcare professionals or administrators, to interact with the data, modify parameters or assumptions, and view updated projections in real-time. This interaction enables the identification of key strategies that can drive desired outcomes and optimize the healthcare system's overall performance.

Once the weights are assigned, the scenario modeling system utilizes the healthcare management model 127, which may encompass one or more algorithms or machine-learning models, to analyze the data and generate predictions. The system considers the relationships between different variables, the potential impact of interventions, and the feasibility of achieving desired outcomes based on the current state of the healthcare system.

Additionally, the scenario modeling system enables users to simulate various scenarios by adjusting the weights of metrics or outcomes, altering assumptions, or modifying input data. This flexibility allows for a thorough exploration of different strategies and their potential outcomes, helping decision-makers to make informed choices that align with the healthcare system's objectives. Furthermore, the scenario modeling system incorporates feedback loops for continuous improvement. As real-world data is collected and analyzed, the system refines its models and adjusts the weights of metrics or outcomes to reflect the most current and accurate information. Furthermore, the scenario modeling system can consider external factors, such as changing regulatory requirements, socio-economic conditions, or advancements in medical technology. This ensures that the system remains adaptive and forward-looking, aligning with the evolving needs of the network environment 100 and the members.

In some embodiments, the method further includes model monitoring. Model monitoring includes assessment of one or more model performance metrics and detecting a drift in the change in the statistical properties of the data that was used to train the data. In some embodiments, the drift is associated with the interventions' impact on the population. As the interventions prove successful, the resulting member population metrics will, in some embodiments, drift from the metrics of the starting population. This drift, in some embodiments, is detected as new health data is populated into the system. The system tracks initial parameters and/or metrics associated with the member data object and identifies changes and/or differences in those parameters over time as new data is populated into the value impact platform 120.

In some embodiments, the value impact platform 120 includes one or more correction mechanisms in response to the detected drift, aiming to adjust and optimize the model for altered data patterns and distributions. These correction mechanisms involve adaptive algorithms that modify model parameters, weight adjustments, or feature recalibration, ensuring that the model remains aligned with the evolving nature of the input data. In certain embodiments, the correction mechanisms employ techniques such as reinforcement learning, transfer learning, or online learning to swiftly adapt to the changing data landscape. Furthermore, these mechanisms might trigger model retraining processes, wherein new data is utilized to update the model, thereby enhancing its predictive accuracy and reliability. In other embodiments, when significant drift is detected, the correction mechanisms might recommend a comprehensive overhaul of the model, encompassing the incorporation of novel features, adjustment of hyperparameters, or even the selection of an alternative modeling approach, thereby maintaining the model's efficacy in dynamically changing environments.

In some embodiments, the value impact platform 120 includes a fairness monitoring to ensure equitable model performance across diverse populations. The value impact platform 120 systematically compares selection rates between predicted outcomes and training data, focusing on attributes/features including but not limited to gender, age, Area Deprivation Index (ADI) codes, Rural-Urban Commuting Area (RUCA) codes, and Social Determinants of Health (SDOH) Socioeconomic Status (SES) metrics. The fairness monitoring process identifies and mitigates biases, ensuring that the model's predictions do not disproportionately favor or disadvantage any group based on these sensitive features. In some embodiments, the value impact platform 120 includes one or more correction mechanisms in response to fairness modeling. In some embodiments, upon detection of bias or drift through the fairness monitoring component, the value impact platform 120 initiates corrective measures to adjust the model. These measures may include retraining the model with augmented datasets, applying algorithmic fairness techniques, or adjusting predictive thresholds. The platform is configured to automatically implement such corrections to ensure that model outputs remain in alignment with one or more predefined fairness criteria, such as equal opportunity, demographic parity, or the like.

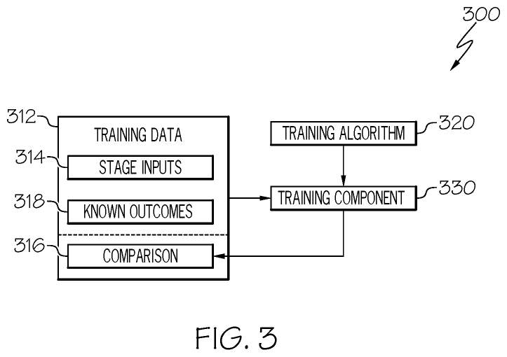

One or more implementations disclosed herein include and/or are implemented using a machine-learning model. For example, one or more of the modules of the value impact platform 120 are implemented using a machine-learning model and/or are used to train the machine-learning model. FIG. 3 shows an example machine-learning training flow chart, according to some embodiments of the disclosure. Referring to FIG. 3, a given machine-learning model is trained using the training flow chart 300. The training data 312 includes one or more of stage inputs 314 and the known outcomes 318 related to the machine-learning model to be trained. The stage inputs 314 are from any applicable source including text, visual representations, data, values, comparisons, and stage outputs, e.g., one or more outputs from one or more steps from FIG. 2. The known outcomes 318 are included for the machine-learning models generated based on supervised or semi-supervised training, or can based on known labels, such as topic labels. An unsupervised machine-learning model is not trained using the known outcomes 318. The known outcomes 318 includes known or desired outputs for future inputs similar to or in the same category as the stage inputs 314 that do not have corresponding known outputs.

The training data 312 and a training algorithm 320, e.g., one or more of the modules implemented using the machine-learning model and/or are used to train the machine-learning model, is provided to a training component 330 that applies the training data 312 to the training algorithm 320 to generate the machine-learning model. According to an implementation, the training component 330 is provided comparison results 316 that compare a previous output of the corresponding machine-learning model to apply the previous result to re-train the machine-learning model. The comparison results 316 are used by the training component 330 to update the corresponding machine-learning model. The training algorithm 320 utilizes machine-learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, and/or discriminative models such as Decision Forests and maximum margin methods, the model specifically discussed herein, or the like.

The machine-learning model used herein is trained and/or used by adjusting one or more weights and/or one or more layers of the machine-learning model. For example, during training, a given weight is adjusted (e.g., increased, decreased, removed) based on training data or input data. Similarly, a layer is updated, added, or removed based on training data/and or input data. The resulting outputs are adjusted based on the adjusted weights and/or layers.

In general, any process or operation discussed in this disclosure is understood to be computer-implementable, such as the process illustrated in FIG. 2 are performed by one or more processors of a computer system as described herein. A process or process step performed by one or more processors is also referred to as an operation. The one or more processors are configured to perform such processes by having access to instructions (e.g., software or computer-readable code) that, when executed by one or more processors, cause one or more processors to perform the processes. The instructions are stored in a memory of the computer system. A processor is a central processing unit (CPU), a graphics processing unit (GPU), or any suitable type of processing unit.

A computer system, such as a system or device implementing a process or operation in the examples above, includes one or more computing devices. One or more processors of a computer system are included in a single computing device or distributed among a plurality of computing devices. One or more processors of a computer system are connected to a data storage device. A memory of the computer system includes the respective memory of each computing device of the plurality of computing devices.

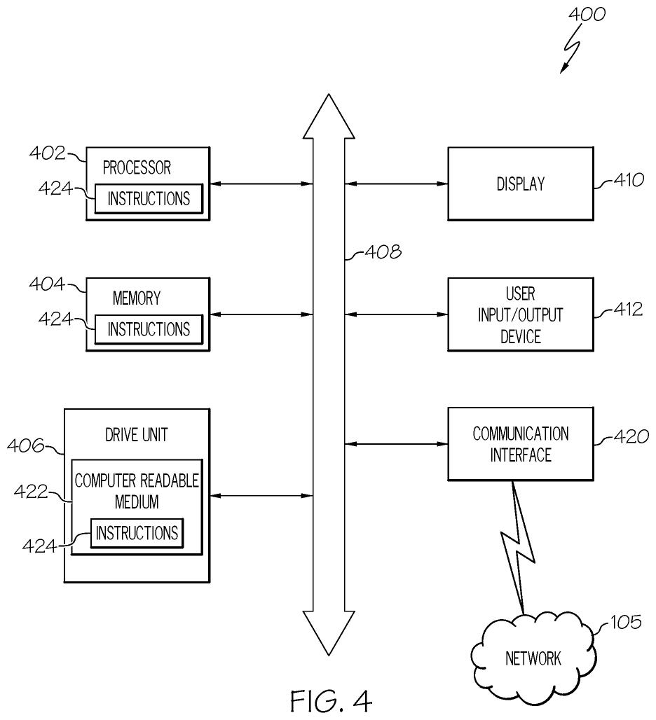

FIG. 4 illustrates an implementation of a computer system that executes techniques presented herein. The computer system 400 includes a set of instructions that are executed to cause the computer system 400 to perform any one or more of the methods or computer based functions disclosed herein. The computer system 400 operates as a standalone device or is connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” refers to any device or portion of a device that processes electronic data, e.g., from registers and/or memory to transform that electronic data into other electronic data that, e.g., is stored in registers and/or memory. A “computer,” a “computing machine,” a “computing platform,” a “computing device,” or a “server” includes one or more processors.

In a networked deployment, the computer system 400 operates in the capacity of a server or as a client user computer in a server-client user network environment, or as a peer computer system in a peer-to-peer (or distributed) network environment. The computer system 400 is also implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the computer system 400 is implemented using electronic devices that provide voice, video, or data communication. Further, while the computer system 400 is illustrated as a single system, the term “system” shall also be taken to include any collection of systems or sub-systems that individually or jointly execute a set, or multiple sets, of instructions to perform one or more computer functions.

As illustrated in FIG. 4, the computer system 400 includes a processor 402, e.g., a central processing unit (CPU), a graphics processing unit (GPU), or both. The processor 402 is a component in a variety of systems. For example, the processor 402 is part of a standard personal computer or a workstation. The processor 402 is one or more processors, digital signal processors, application specific integrated circuits, field programmable gate arrays, servers, networks, digital circuits, analog circuits, combinations thereof, or other now known or later developed devices for analyzing and processing data. The processor 402 implements a software program, such as code generated manually (i.e., programmed).

The computer system 400 includes a memory 404 that communicates via bus 408. The memory 404 is a main memory, a static memory, or a dynamic memory. The memory 404 includes, but is not limited to computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 404 includes a cache or random-access memory for the processor 402. In alternative implementations, the memory 404 is separate from the processor 402, such as a cache memory of a processor, the system memory, or other memory. The memory 404 is an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts, or tasks illustrated in the figures or described herein are performed by the processor 402 executing the instructions stored in the memory 404. The functions, acts, or tasks are independent of the particular type of instruction set, storage media, processor, or processing strategy and are performed by software, hardware, integrated circuits, firmware, micro-code, and the like, operating alone or in combination. Likewise, processing strategies include multiprocessing, multitasking, parallel processing, and the like.

As shown, the computer system 400 further includes a display 410, such as a liquid crystal display (LCD), an organic light emitting diode (OLED), a flat panel display, a solid-state display, a cathode ray tube (CRT), a projector, a printer or other now known or later developed display device for outputting determined information. The display 410 acts as an interface for the user to see the functioning of the processor 402, or specifically as an interface with the software stored in the memory 404 or in the drive unit 406.

Additionally or alternatively, the computer system 400 includes an input/output device 412 configured to allow a user to interact with any of the components of the computer system 400. The input/output device 412 is a number pad, a keyboard, a cursor control device, such as a mouse, a joystick, touch screen display, remote control, or any other device operative to interact with the computer system 400.

The computer system 400 also includes the drive unit 406 implemented as a disk or optical drive. The drive unit 406 includes a computer-readable medium 422 in which one or more sets of instructions 424, e.g. software, is embedded. Further, the sets of instructions 424 embodies one or more of the methods or logic as described herein. The sets of instructions 424 resides completely or partially within the memory 404 and/or within the processor 402 during execution by the computer system 400. The memory 404 and the processor 402 also include computer-readable media as discussed above.

In some systems, computer-readable medium 422 includes the set of instructions 424 or receives and executes the set of instructions 424 responsive to a propagated signal so that a device connected to network 105 communicates voice, video, audio, images, or any other data over the network 105. Further, the sets of instructions 424 are transmitted or received over the network 105 via the communication port or interface 420, and/or using the bus 408. The communication port or interface 420 is a part of the processor 402 or is a separate component. The communication port or interface 420 is created in software or is a physical connection in hardware. The communication port or interface 420 is configured to connect with the network 105, external media, the display 410, or any other components in the computer system 400, or combinations thereof. The connection with the network 105 is a physical connection, such as a wired Ethernet connection, or is established wirelessly as discussed below. Likewise, the additional connections with other components of the computer system 400 are physical connections or are established wirelessly. The network 105 alternatively be directly connected to the bus 408.

While the computer-readable medium 422 is shown to be a single medium, the term “computer-readable medium” includes a single medium or multiple media, such as a centralized or distributed database, and/or associated caches and servers that store one or more sets of instructions. The term “computer-readable medium” also includes any medium that is capable of storing, encoding, or carrying a set of instructions for execution by a processor or that causes a computer system to perform any one or more of the methods or operations disclosed herein. The computer-readable medium 422 is non-transitory, and may be tangible.

The computer-readable medium 422 includes a solid-state memory such as a memory card or other package that houses one or more non-volatile read-only memories. The computer-readable medium 422 is a random-access memory or other volatile re-writable memory. Additionally or alternatively, the computer-readable medium 422 includes a magneto-optical or optical medium, such as a disk or tapes or other storage device to capture carrier wave signals such as a signal communicated over a transmission medium. A digital file attachment to an e-mail or other self-contained information archive or set of archives is considered a distribution medium that is a tangible storage medium. Accordingly, the disclosure is considered to include any one or more of a computer-readable medium or a distribution medium and other equivalents and successor media, in which data or instructions are stored.

In an alternative implementation, dedicated hardware implementations, such as application specific integrated circuits, programmable logic arrays, and other hardware devices, is constructed to implement one or more of the methods described herein. Applications that include the apparatus and systems of various implementations broadly include a variety of electronic and computer systems. One or more implementations described herein implement functions using two or more specific interconnected hardware modules or devices with related control and data signals that are communicated between and through the modules, or as portions of an application-specific integrated circuit. Accordingly, the present system encompasses software, firmware, and hardware implementations.

Computer system 400 is connected to the network 105. The network 105 defines one or more networks including wired or wireless networks. The wireless network is a cellular telephone network, an 802.10, 802.16, 802.20, or WiMAX network. Further, such networks include a public network, such as the Internet, a private network, such as an intranet, or combinations thereof, and utilizes a variety of networking protocols now available or later developed including, but not limited to TCP/IP based networking protocols. The network 105 includes wide area networks (WAN), such as the Internet, local area networks (LAN), campus area networks, metropolitan area networks, a direct connection such as through a Universal Serial Bus (USB) port, or any other networks that allows for data communication. The network 105 is configured to couple one computing device to another computing device to enable communication of data between the devices. The network 105 is generally enabled to employ any form of machine-readable media for communicating information from one device to another. The network 105 includes communication methods by which information travels between computing devices. The network 105 is divided into sub-networks. The sub-networks allow access to all of the other components connected thereto or the sub-networks restrict access between the components. The network 105 is regarded as a public or private network connection and includes, for example, a virtual private network or an encryption or other security mechanism employed over the public Internet, or the like.

In accordance with various implementations of the present disclosure, the methods described herein are implemented by software programs executable by a computer system. Further, in an example, non-limited implementation, implementations can include distributed processing, component/object distributed processing, and parallel processing. Alternatively, virtual computer system processing can be constructed to implement one or more of the methods or functionality as described herein.

Although the present specification describes components and functions that are implemented in particular implementations with reference to particular standards and protocols, the disclosure is not limited to such standards and protocols. For example, standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure is implemented using any appropriate techniques for implementing the functionality described herein. The disclosure is not limited to any particular programming language or operating system.

It should be appreciated that in the above description of example embodiments of the disclosure, various features of the disclosure are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed disclosure requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the instructions for carrying out such a method or element of a method forms a means for carrying out the method or element of a method. Furthermore, an element described herein of an apparatus embodiment is an example of a means for carrying out the function performed by the element for the purpose of carrying out the disclosure.

In the description provided herein, numerous specific details are set forth. However, it is understood that embodiments of the disclosure are practiced without these specific details. In other instances, well-known methods, structures and techniques have not been shown in detail in order not to obscure an understanding of this description.

Thus, while there has been described what are believed to be the preferred embodiments of the disclosure, those skilled in the art will recognize that other and further modifications are made thereto without departing from the spirit of the disclosure, and it is intended to claim all such changes and modifications as falling within the scope of the disclosure. For example, any formulas given above are merely representative of procedures that may be used. Functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

The present disclosure furthermore relates to the following aspects:

Example 1. A computer-implemented method, the method comprising: receiving, by one or more processors, a first data object, the first data object including: a member data set containing a plurality of members; a first classification data set; a second classification data set; and a plurality of data sets associated with one or more metrics; generating, by the one or more processors and for each member of the plurality of members: a usage indicator for a pre-determined time period based on at least one of the member data set or one or more of the plurality of data sets associated with the one or more metrics, wherein generating the usage indicator is performed using a first machine-learning model trained to identify associations between prior usage of a resource and future usage of the resource; and a usage rate for the pre-determined time period based on the usage indicator and at least one of the member data set or one or more of the plurality of data sets associated with the one or more metrics; generating, by the one or more processors and for each member of the plurality of members, based at least on the first classification data set, the second classification data set, the usage indicator, and the usage rate, a member optimization parameter; generating, by the one or more processors, based at least on the usage indicator, the usage rate, and the member optimization parameter for each member of the plurality of members, a plurality of cluster data objects, wherein members of each cluster data object are unique from members of any other cluster data object; and causing, by the one or more processors, at least one of the plurality of cluster data objects to be displayed on a Graphical User Interface (GUI).

Example 2. The computer-implemented method of Example 1, further comprising: adjusting, by the one or more processors, the first machine-learning model based on one or more data objects received by the one or more processors, the adjustment resulting in the first machine-learning model being more optimally configured to identify associations between prior usage of a resource and future usage of the resource.

Example 3. The computer-implemented method of Example 2, wherein generating the usage rate for the pre-determined time period is performed using a second machine-learning model trained to identify associations between prior usage of a resource and a rate of future usage.

Example 4. The computer-implemented method of Example 3, further comprising: adjusting, by the one or more processors, the second machine-learning model based on one or more data objects received by the one or more processors, the adjustment resulting in the second machine-learning model being more optimally configured to identify associations between prior usage of a resource and a rate of future usage.

Example 5. The computer-implemented method of any of Examples 1-4, further comprising: generating, by the one or more processors, one or more labels for each cluster data object based on common member data for the members associated with the cluster data object.

Example 6. The computer-implemented method of Example 5, further comprising: assigning a recommended intervention for each member of the plurality of members based on at least one of the label for a cluster data object associated with the member or the usage rate for the member.

Example 7. The computer-implemented method of Example 6, wherein assigning the recommended intervention for each member is further based at least in part on one or more scenario models.

Example 8. The computer-implemented method of any of Examples 1-7, wherein the first classification data set includes one or more indicators that one or more utilizations are avoidable.

Example 9. The computer-implemented method of Example 8, wherein the second classification data set includes one or more indicators related to an amount of resource use of one or more utilizations.

Example 10. A system comprising: memory and one or more processors communicatively coupled to the memory, the one or more processors configured to: receive a first data object, the first data object including: a member data set containing a plurality of members; a first classification data set; a second classification data set; and a plurality of data sets associated with one or more metrics; generate for each member of the plurality of members: a usage indicator for a pre-determined time period based on at least one of the member data set or one or more of the plurality of data sets associated with the one or more metrics, wherein generating the usage indicator is performed using a first machine-learning model trained to identify associations between prior usage of a resource and future usage of the resource; and a usage rate for the pre-determined time period based on the usage indicator and at least one of the member data set or one or more of the plurality of data sets associated with the one or more metrics; generate for each member of the plurality of members, based at least on the first classification data set, the second classification data set, the usage indicator, and the usage rate, a member optimization parameter; generate, based at least on the usage indicator, the usage rate, and the member optimization parameter for each member of the plurality of members, a plurality of cluster data objects, wherein members of each cluster data object are unique from members of any other cluster data object; and cause at least one of the plurality of cluster data objects to be displayed on a Graphical User Interface (GUI).

Example 11. The system of Example 10, the one or more processors further configured to adjust the first machine-learning model based on one or more data objects received by the one or more processors, the adjustment resulting in the first machine-learning model being more optimally configured to identify associations between prior usage of a resource and future usage of the resource.

Example 12. The system of Example 11, wherein generating the usage rate for the pre-determined time period is performed using a second machine-learning model trained to identify associations between prior usage of a resource and a rate of future usage.

Example 13. The system of Example 12, the one or more processors further configured to: adjusting the second machine-learning model based on one or more data objects received by the one or more processors, the adjustment resulting in the second machine-learning model being more optimally configured to identify associations between prior usage of a resource and a rate of future usage.

Example 14. The system of any of Examples 10-13, the one or more processors further configured to generate one or more labels for each cluster data object based on common member data for the members associated with the cluster.

Example 15. The system of Example 14, the one or more processors further configured to assign a recommended intervention for each member of the plurality of members based on at least one of the label for a cluster data object associated with the member or the usage rate for the member.

Example 16. The system of Example 15, wherein assigning the recommended intervention for each member is further based at least in part on one or more scenario model.

Example 17. The system of any of Examples 10-16, wherein the first classification data set includes one or more indicators that one or more utilizations are avoidable.

Example 18. The system of Example 17, wherein the second classification data set includes one or more indicators related to an amount of resource use of one or more utilizations.

Example 19. One or more non-transitory computer-readable storage media including instructions that, when executed by one or more processors, cause the one or more processors to: receive a first data object, the first data object including: a member data set containing a plurality of members; a first classification data set; a second classification data set; and a plurality of data sets associated with one or more metrics; generate for each member of the plurality of members: a usage indicator for a pre-determined time period based on at least one of the member data set or one or more of the plurality of data sets associated with the one or more metrics, wherein generating the usage indicator is performed using a first machine-learning model trained to identify associations between prior usage of a resource and future usage of the resource; and a usage rate for the pre-determined time period based on the usage indicator and at least one of the member data set or one or more of the plurality of data sets associated with the one or more metrics; generate for each member of the plurality of members, based at least on the first classification data set, the second classification data set, the usage indicator, and the usage rate, a member optimization parameter; generate, based at least on the usage indicator, the usage rate, and the member optimization parameter for each member of the plurality of members, a plurality of cluster data objects, wherein members of each cluster data object are unique from members of any other cluster data object; and cause at least one of the plurality of cluster data objects to be displayed on a Graphical User Interface (GUI).

Example 20. The one or more non-transitory computer-readable storage media of Example 19, the one or more processors further configured to adjust the first machine-learning model based on one or more data objects received by the one or more processors, the adjustment resulting in the first machine-learning model being more optimally configured to identify associations between prior usage of a resource and future usage of the resource, and wherein generating the usage rate for the pre-determined time period is performed using a second machine-learning model trained to identify associations between prior usage of a resource and a rate of future usage.

What is claimed is:

1. A computer-implemented method, the method comprising:
receiving, by one or more processors, a first data object, the first data object including:
a member data set containing a plurality of members;
a first classification data set;
a second classification data set; and
a plurality of data sets associated with one or more metrics;
generating, by the one or more processors and for each member of the plurality of members:
a usage indicator for a pre-determined time period based on at least one of the member data set or one or more of the plurality of data sets associated with the one or more metrics, wherein generating the usage indicator is performed using a first machine-learning model trained to identify associations between prior usage of a resource and future usage of the resource; and
a usage rate for the pre-determined time period based on the usage indicator and at least one of the member data set or one or more of the plurality of data sets associated with the one or more metrics;
generating, by the one or more processors and for each member of the plurality of members, based at least on the first classification data set, the second classification data set, the usage indicator, and the usage rate, a member optimization parameter;
generating, by the one or more processors, based at least on the usage indicator, the usage rate, and the member optimization parameter for each member of the plurality of members, a plurality of cluster data objects, wherein members of each cluster data object are unique from members of any other cluster data object; and
causing, by the one or more processors, at least one of the plurality of cluster data objects to be displayed on a Graphical User Interface (GUI).

2. The computer-implemented method of claim 1, further comprising: adjusting, by the one or more processors, the first machine-learning model based on one or more data objects received by the one or more processors, the adjustment resulting in the first machine-learning model being more optimally configured to identify associations between prior usage of a resource and future usage of the resource.

3. The computer-implemented method of claim 2, wherein generating the usage rate for the pre-determined time period is performed using a second machine-learning model trained to identify associations between prior usage of a resource and a rate of future usage.

4. The computer-implemented method of claim 3, further comprising: adjusting, by the one or more processors, the second machine-learning model based on one or more data objects received by the one or more processors, the adjustment resulting in the second machine-learning model being more optimally configured to identify associations between prior usage of a resource and a rate of future usage.

5. The computer-implemented method of claim 1, further comprising:
generating, by the one or more processors, one or more labels for each cluster data object based on common member data for the members associated with the cluster data object.

6. The computer-implemented method of claim 5, further comprising:
assigning a recommended intervention for each member of the plurality of members based on at least one of the label for a cluster data object associated with the member or the usage rate for the member.

7. The computer-implemented method of claim 6, wherein assigning the recommended intervention for each member is further based at least in part on one or more scenario models.

8. The computer-implemented method of claim 1, wherein the first classification data set includes one or more indicators that one or more utilizations are avoidable.

9. The computer-implemented method of claim 8, wherein the second classification data set includes one or more indicators related to an amount of resource use of one or more utilizations.

10. A system comprising: memory and one or more processors communicatively coupled to the memory, the one or more processors configured to:
receive a first data object, the first data object including:
a member data set containing a plurality of members;
a first classification data set;
a second classification data set; and
a plurality of data sets associated with one or more metrics;
generate for each member of the plurality of members:
a usage indicator for a pre-determined time period based on at least one of the member data set or one or more of the plurality of data sets associated with the one or more metrics, wherein generating the usage indicator is performed using a first machine-learning model trained to identify associations between prior usage of a resource and future usage of the resource; and
a usage rate for the pre-determined time period based on the usage indicator and at least one of the member data set or one or more of the plurality of data sets associated with the one or more metrics;
generate for each member of the plurality of members, based at least on the first classification data set, the second classification data set, the usage indicator, and the usage rate, a member optimization parameter;
generate, based at least on the usage indicator, the usage rate, and the member optimization parameter for each member of the plurality of members, a plurality of cluster data objects, wherein members of each cluster data object are unique from members of any other cluster data object; and
cause at least one of the plurality of cluster data objects to be displayed on a Graphical User Interface (GUI).

11. The system of claim 10, the one or more processors further configured to adjust the first machine-learning model based on one or more data objects received by the one or more processors, the adjustment resulting in the first machine-learning model being more optimally configured to identify associations between prior usage of a resource and future usage of the resource.

12. The system of claim 11, wherein generating the usage rate for the pre-determined time period is performed using a second machine-learning model trained to identify associations between prior usage of a resource and a rate of future usage.

13. The system of claim 12, the one or more processors further configured to: adjusting the second machine-learning model based on one or more data objects received by the one or more processors, the adjustment resulting in the second machine-learning model being more optimally configured to identify associations between prior usage of a resource and a rate of future usage.

14. The system of claim 10, the one or more processors further configured to generate one or more labels for each cluster data object based on common member data for the members associated with the cluster.

15. The system of claim 14, the one or more processors further configured to assign a recommended intervention for each member of the plurality of members based on at least one of the label for a cluster data object associated with the member or the usage rate for the member.

16. The system of claim 15, wherein assigning the recommended intervention for each member is further based at least in part on one or more scenario model.

17. The system of claim 10, wherein the first classification data set includes one or more indicators that one or more utilizations are avoidable.

18. The system of claim 17, wherein the second classification data set includes one or more indicators related to an amount of resource use of one or more utilizations.

19. One or more non-transitory computer-readable storage media including instructions that, when executed by one or more processors, cause the one or more processors to:
receive a first data object, the first data object including:
a member data set containing a plurality of members;
a first classification data set;
a second classification data set; and
a plurality of data sets associated with one or more metrics;
generate for each member of the plurality of members:
a usage indicator for a pre-determined time period based on at least one of the member data set or one or more of the plurality of data sets associated with the one or more metrics, wherein generating the usage indicator is performed using a first machine-learning model trained to identify associations between prior usage of a resource and future usage of the resource; and
a usage rate for the pre-determined time period based on the usage indicator and at least one of the member data set or one or more of the plurality of data sets associated with the one or more metrics;
generate for each member of the plurality of members, based at least on the first classification data set, the second classification data set, the usage indicator, and the usage rate, a member optimization parameter;
generate, based at least on the usage indicator, the usage rate, and the member optimization parameter for each member of the plurality of members, a plurality of cluster data objects, wherein members of each cluster data object are unique from members of any other cluster data object; and
cause at least one of the plurality of cluster data objects to be displayed on a Graphical User Interface (GUI).

20. The one or more non-transitory computer-readable storage media of claim 19, the one or more processors further configured to adjust the first machine-learning model based on one or more data objects received by the one or more processors, the adjustment resulting in the first machine-learning model being more optimally configured to identify associations between prior usage of a resource and future usage of the resource, and wherein generating the usage rate for the pre-determined time period is performed using a second machine-learning model trained to identify associations between prior usage of a resource and a rate of future usage.
